(19) United States
(12) Patent Application Publication
(10) Pub. No.: US 2012/0154107 A1
(43) Pub. Date: Jun. 21, 2012

(54) Fail-safe, programmable electronic communication transducer which, when attached to a padlock or security cable, signals the integrity of said padlock or security cable.

(76) Inventor: Robert William Dzuris, Chelmsford, MA (US)

(21) Appl. No.: 12/928,798

(22) Filed: Dec. 20, 2010

(51) Int. Cl. G05B 23/02

(52) U.S. Cl. 340/3.32

(57) ABSTRACT

The largest of padlocks or security cables are easily defeated with bolt cutters. Thieves can readily sever the shackle of a padlock or a cable and hook up a trailer loaded with an expensive boat or other expensive equipment; and be off with it. Since padlocks currently do not wirelessly excite deterrents such as audio or visual alarms or alert authorities, thieves can conduct their nefarious activities in stealth. The GOTCHA alerts loud audible alarms, flashing lights and can activate scrutiny systems as both a deterrent and a means of alerting the powers that be. The GOTCHA is portable, wireless, and impervious to the effects of weather; and its protection cannot be defeated by destroying it. The GOTCHA accessory makes a padlock a part of a security system.

For the purpose of this patent the term GOTCHA pertains to the above titled device. The GOTCHA is a weather impervious transducer which, when attached to the shank of a padlock or installed on a security cable, enables the padlock or security cable to become an electronically integral part of a home or industrial security system or other alarming device. Any attempt to defeat the GOTCHA, security of the padlock, or security cable to which a GOTCHA is attached, causes the GOTCHA transmitter to cease transmitting; thus alerting a remotely located receiver to activate a horn, siren, lighting or security system; accomplishing this function by both the GOTCHAS′S physical and electronic design; which ceases transmitting whenever there is an attempt to defeat it's purpose.

### FEDERALLY SPONSORED RESEARCH OR DEVELOPMENT

No federally sponsored research or development was involved in the creation of the entitled device.

### BACKGROUND OF THE INVENTION

Recently the theft of a padlocked trailer containing two snow mobiles and weather gear was stolen from my yard. This experience illustrated the ineffectiveness of a padlock to secure valuable property. Padlocks and security cables are in wide use to protect valuable property. Prior art depends on the mechanical resistance offered by padlocks and security cables as a deterrent to theft. Padlocks and Security Cables are easily defeated within a few seconds with modern tools and they have no means of wireless alarm or electronic communication with security systems to deter thieves.

The GOTCHA provides padlocks and security cables the means for security systems to activate a wide variety of alarms. The use of the invention begins with the need to protect items of great value such as boats, snow mobiles, wave runners, quads, bicycles and other valuable property normally protected by padlocks or security cables. Such items are commonly stored behind padlocked fences, secured with security cables or mounted and stored on open or enclosed trailers which are also commonly secured with padlocks. The 2002 U.S. Department of Transportation Highway Statistics reports over 45 million private, commercial, state and federally owned trailers were registered in the United States. One pleasure boat insurance company reports 14,000 boats are stolen each year. It is apparent that my experience is repeated many times each year given these statistics.

### BRIEF DESCRIPTION OF DRAWINGS

FIG. 1 is an outside front and top view drawing of the GOTCHA.

FIG. 2 is a side and top view showing internal components of the GOTCHA. The shank of a padlock or a security cable is inserted through the aperture shown as part of the Sensor Assembly pictured in both FIGS. 1 and 2. FIG. 2 shows the encapsulation of a coil surrounding the outer body of this aperture which forms a part of the Sensor assembly. The Sensor Assembly coil is attached to the electronic circuitry when screwed into the Tubular Section. The battery power supply is connected to the electronics by means of an internal battery retainer which permits the use of a spring loaded assembly and electronic attachment of the batteries to the electronics. The batteries are loaded from the bottom of the Tubular Section. The spring loaded Pressure Plate assembly mechanically secures the batteries and provides the force to assure the batteries make contact to the circuit board when it is screwed into the Tubular Section. The Program Buttons which is shown in both figures are attached to the electronic circuitry by means of a cable.

FIG. 3 is a drawing of the GOTCHA functional diagram. The function and inter-relation of the circuitry described in the Detailed Description of the Invention is evidenced here. The oscillator provides the stimulus to the coil surrounding the aperture. Once the GOTCHA is installed on the shank of a padlock or security cable and the operating code is impressed upon the Program Buttons, the impedance measuring circuitry determines the combined impedance of the lock or cable to which the GOTCHA is attached. The memory circuit records and saves this initial impedance measurement. The comparator circuit continuously makes impedance measurements for comparison to the original measurement stored in memory. All measurements subsequent to the initial measurement are first integrated three times to determine if the shifts in impedance are to be ignored; such as may be caused by the effects of weather, or whether the newly measured shift signals a security breach. If there is no security breach the normal logic 1 output state of the Latching Device remains at the input of the transmitter signifying there is no breach and the transmitter will continue to transmit. If there is a breach of security the Latching Device output will go to a logic 0 (zero) which terminates transmitter operation which in turn will alert the security device to which it is allied.

### DETAILED DESCRIPTION OF THE INVENTION

The GOTCHA is believed to be unique. No other similar inventions for use with padlocks or security cables could be found to enable comparison.

The use of a GOTCHA is designed to be a light weight self contained wireless transducer designed to mount on the shackle of a padlock or security cable by means of an aperture, for the purpose of communicating the integrity the padlock or security cable was meant to provide; and to provide an output state, which, when interpreted by a receiver as a security breach, will activate a wide variety of alarms and security systems.

The following description of how the GOTCHA operates, begins with the assumption that all 6 AA alkaline batteries have been loaded into the Tubular Section of the GOTCHA, the bottom Pressure Plate Assembly and Sensor Assembly has been screwed into place and the aperture of the GOTCHA has been installed on the shank of a padlock or security cable; and, the shank of the padlock, or the security cable is engaged in the normal fashion for the padlock or security cable to exclude unauthorized access to whatever it is attached.

The GOTCHA is turned on when the owner chooses a 4 digit pin code and enters it on the GOTCHA 4 digit Program Buttons. This action activates the GOTCHA and begins the process of learning the impedance of the combined electronic circuit formed by the GOTCHA and the padlock or security cable to which it is attached.

To learn the combined impedance of the GOTCHA and the padlock or security cable to which it is attached, the GOTCHA uses several codependent components. The first component being the Shackle Sensor Assembly which is an assembly mounted to the Tubular

Section of the GOTCHA; and is comprised of a Coil Winding molded around the outside diameter of the aperture and connected to electronic circuitry when the Sensor Assembly is screwed into the Tubular Section. The Sensor assembly impresses a low energy oscillator signal to the coil which enables the impedance measuring circuitry of the GOTCHA to measure the combined impedance of the GOTCHA and the shackle or cable to which it has been attached. Once the beginning impedance is determined, the circuitry remembers this impedance in two memory locations entitled Mem 1 and Mem 2; the Latching Device provides a logic one (1) output as evidence of the presence of the initial impedance value. The logic one (1) output of the Latching Device remains constant as long as each subsequent impedance measurement remains constant. Impedance changes will take place as a consequence of weather related changes such as humidity, rain, snow, ice, wind, and oxidation as well as incursion. However, the characteristics of these impedance shifts are compensated for within GOTCHA. Said shifts are examined by measuring the level of impedance shift after each of 3 successive integrations of the shift. This practice enables the characteristics of velocity, acceleration and jerk of changes peculiar to the various effects upon impedance shifts be undertaken. If any of the 3 integration output levels, after compensation, exhibit characteristics of a security breach, the comparator circuit then compares that output for comparison to Mem 1. If none of the outputs exhibits characteristics of a breach, the comparator selects Mem 2 to compare with Mem 1. Thus the combined measurement, memory, integration, compensation and comparator circuitry of the Latching Device nullifies the effects of these weather related changes in impedance; leaving only the shifts of impedance common to unauthorized interference, to cause the Latching Device to produce a logic zero (0) output. The logic zero (0) is interpreted by the Encrypted Transmitter circuitry as an unauthorized intrusion to the security of the padlock and terminates further transmitting. The normal state of the Encrypted Transmitter is to transmit periodically a pulse of specific shape, duration and repetition rate; which if terminated, or jammed, signals a security breach since the receiver of a security system or other device is designed to recognize only the specific shape, duration and repetition rate of the GOTCHA.

The transmitter operates on frequency bands prescribed by the FCC for wireless transmission devices of this type. Any attempt to destroy or disassemble the GOTCHA will result in logic zero (0) at the Latching Device output and termination of transmissions.

The GOTCHA cannot be turned off without the customer's chosen security code. The GOTCHA will interpret incorrect security code entries as a security breach. Turning off the GOTCHA with the customer's chosen security code forces the Latching Device to sustain logic 1 output. This feature enables customer freedom of access without the necessity of disabling the security system with which the GOTCHA is allied. The customer's security code was established upon first activating the GOTCHA so there is no written evidence of the code. The transmitting range of the GOTCHA is 150 to 300 feet depending upon surroundings. Depending upon battery quality and temperatures of operation, battery life is 4 to 6 months. Battery replacement is accomplished by first turning off the security system with which the GOTCHA is allied, removing the Pressure Plate Assembly to enable battery removal and replacement, and once new batteries have been correctly reinserted, the original 4 digit pin code must be reentered to activate the GOTCHA and the security system with which the GOTCHA is allied may be turned back on.

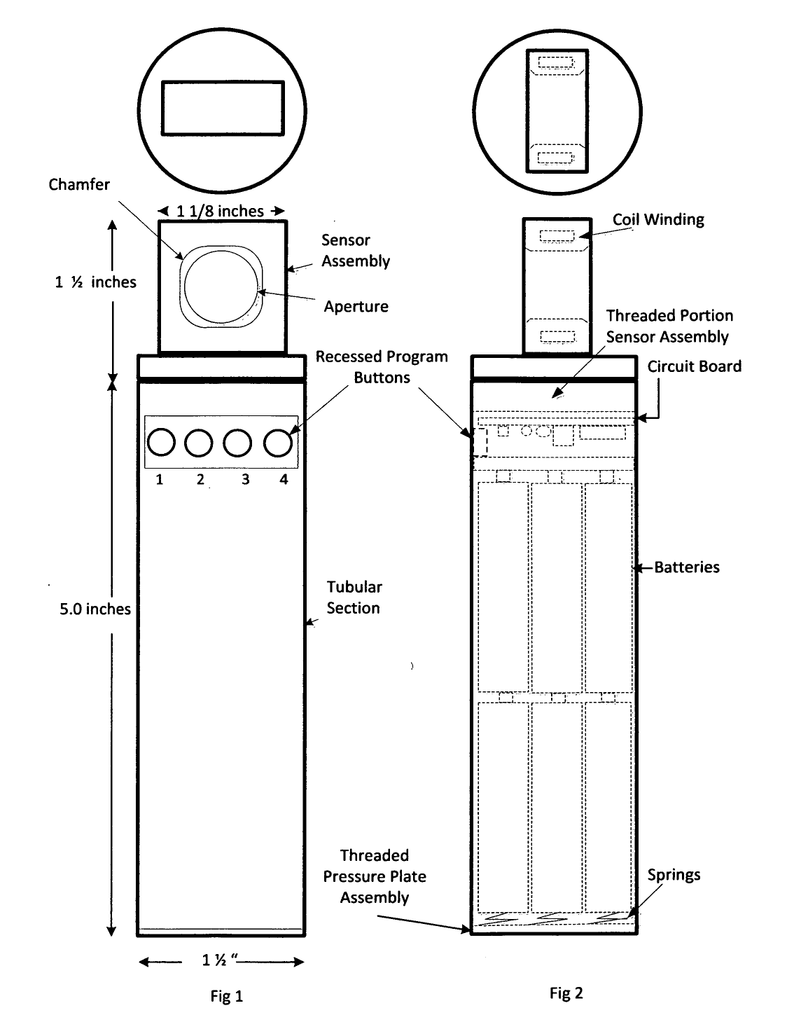

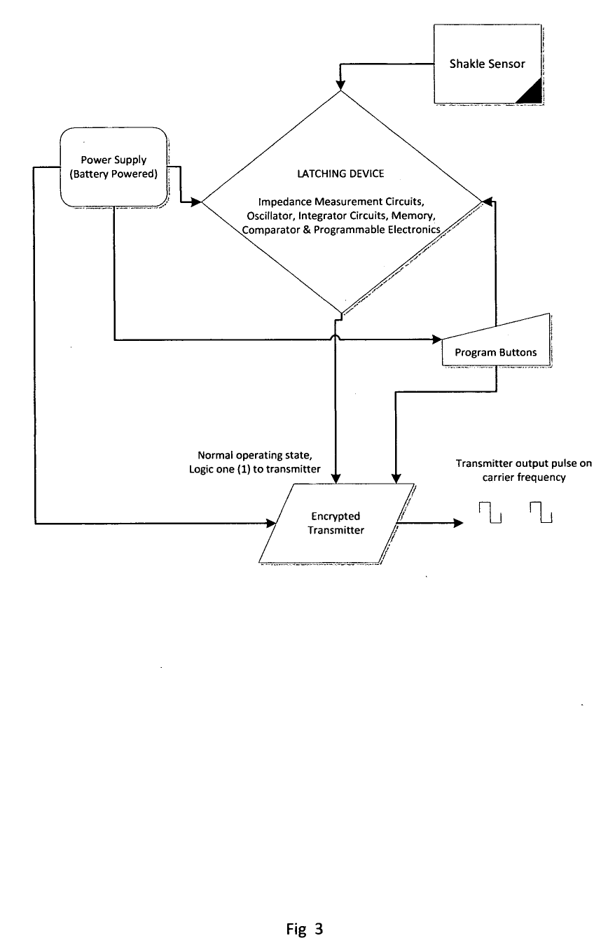

The Power Supply and Sensor assembly and all electronics are contained within or attached to the Tubular Section of the GOTCHA. The power supply can be made interchangeable for use with a re-chargeable battery, or 115 volt a.c. power. The power supply is changed by removing the pressure plate, removing the batteries and reinserting the chosen accessory power supply. The Sensor Assembly is attached to the electronics when it is screwed into the Tubular Section. The Power Supply makes contact with the Circuit board by virtue of the pressure supplied by screwing in of the Pressure Plate Assembly. GOTCHA′S are furnished with Sensor Assemblies which form a right angle to the Tubular Section to accommodate physical space constraints caused by the in line configuration shown in FIGS. 1 & 2.

1. A method whereby, when a device is attached to a padlock or security cable and activated, it learns the impedance of the combination; unauthorized attempts to defeat the security of the combination, results in the device wirelessly enabling a security system receiver of a security breach without false alarms caused by weather related shifts in impedance.

2. The method of claim 1, whereas a seamless aperture is used to insure a mechanical attachment to the shackle of a padlock or security cable; and whereas this mechanical design of such a device is such that the aperture cannot be separated from the shackle of a padlock or security cable without destroying one or the other; which would result in the device wirelessly enabling a security system receiver of a security breach.

3. The method of claim 1, whereas the impedance measurement of the padlock or security cable will vary with size, metallurgy and weather, the shackle sensor circuitry makes an impedance measurement of the union of the GOTCHA and the specific device to which it is attached and creates a value reflective of that unity created by the attachment. Changes in the established value as caused by the effects of weather are ignored by means of examining three integrations of any impedance change.

4. The method of claim 2 is perfected by the aperture in FIG. 1; where the inside diameter of which can be offered in different sizes to fit a variety of shackle and cable diameters.

5. The method of claim 2 can offer right angle versions of the Sensor Assembly to accommodate a number of physical space requirements.

6. The method of claim 3 is the comparison of the initial impedance versus the analysis at the juncture of each of three contiguous integrations of the a single impedance shift; and uses two memory locations where each location stores the same initial impedance value, to determine whether or not a security breach has occurred or not independent of weather related effects.

7. The method of Clam 4 incorporates, irrespective of aperture I.D., a chamfer on both sides of the aperture which enhances placement around the radius of the device to which it is attached maximizing electrical contact, ease of attachment and maximized conductivity.

8. The method of claim 3 uses the measurement of velocity, acceleration and jerk to achieve its ability to discriminate between the erroneous effects of weather and unauthorized attempts to defeat the security of a lock or security cable.

9. The method of claim 3 uses an energy saving wireless encrypted transmitter which transmits a pulse of specific shape, duration and repetition rate which if terminated or jammed, signals a security breach since the receiver is designed to recognize only the specific shape, duration and repetition rate.

10. The method of claim 3 enables the same advantages of discriminating between the effects of weather for other electronic security applications where weather is an undesirable variable.

11. The methods of claims 1, 2 and 3 uses a variety of accessory power supplies to meet unique applications where one or the other accessory power supply is more suitable.

12. The method of claim 3 uses a transmitter encryption method that enhances battery life since the transmitter is not running continuously.

13. The method of claim 1 whereby the breach of a padlock or cable is detected by a device that is programmed by means of an electronic key pad.
